(19) United States
(12) Patent Application Publication
(10) Pub. No.: US 2022/0083345 A1
(43) Pub. Date: Mar. 17, 2022

(54) BOOTING PROCESSORS

(71) Applicant: Hewlett-Packard Development Company, L.P., Spring, TX (US)

(72) Inventors: Hsintien Lin, Taipei City (TW); Heng-Fu Chang, Taipei City (TW); Ming Chang Hung, Taipei City (TW)

(73) Assignee: Hewlett-Packard Development Company, L.P., Spring, TX (US)

(21) Appl. No.: 17/419,387

(22) PCT Filed: Apr. 30, 2019
(86) PCT No.: PCT/US2019/030040

§ 371 Date: Jun. 29, 2021

(51) Int. Cl. G06F 9/4401

(52) U.S. Cl. CPC G06F 9/4403

(57) ABSTRACT

Examples for booting a processor are described herein. In an example, a pure hardware parameter associated with a processor, from amongst a plurality of processors, is determined to identify the processor. A firmware appropriate for booting of the processor is identified, based on the identified processor. Then, a Serial Peripheral Interface Read-Only Memory (SPI-ROM) is selected for loading the identified firmware to boot the identified processor. As part of selecting the firmware, the identified firmware is loaded to the SPI-ROM.

### BACKGROUND

Computing systems, such as those having multiple processing unit circuits, find ubiquitous use in a variety of applications including home appliances and consumer electronics. Generally, the processing unit circuits of such systems are designed to be forward compatible. For example, a printed circuit board (PCB), for example, a motherboard, may be designed in a way that it supports use of different generations and versions of processors, including later generations and versions. Such a design allows the same processing unit circuit to be used across various systems from a manufacturer's perspective as well as to remain in use for a long time from a consumer's perspective.

### BRIEF DESCRIPTION OF FIGURES

The detailed description is provided with reference to the accompanying figures, wherein:

FIG. 1 illustrates a schematic of a Read-Only-Memory (ROM) selection unit to boot a processor, according to an example;

FIG. 2 illustrates a detailed schematic of the ROM selection unit, according to an example;

FIG. 3 illustrates a method to boot a processor, according to an example.

FIG. 4 illustrates a detailed method to boot a processor, according to an example.

FIG. 5 illustrates a network environment to boot a processor, according to an example.

It should be noted that the description and the figures are merely examples of the present subject matter and are not meant to represent the subject matter itself. Throughout the drawings, identical reference numbers designate similar, but not identical, elements. The figures are not to scale, and the size of some parts may be exaggerated to more clearly illustrate the example shown. Moreover, the drawings provide examples and/or examples consistent with the description; however, the description is not limited to the examples and/or examples provided in the drawings.

### DETAILED DESCRIPTION

Generally, the processing unit circuits of such systems are designed to be forward compatible so that the same processing unit circuit can be used across various systems as well as can remain in use for a long time. As an example, as part of an initializing mechanism of a computing system, the processing unit circuit includes a Serial Peripheral Interface Read-Only Memory (SPI-ROM) which is operably coupled to the processing unit circuit. For example, the processors on the processing unit circuit can interact with SPI-ROM that provides support for, amongst other things, an initialization operation associated with the computing system which is used for starting up the computing system. For example, the SPI-ROM may be used for supporting a basic input-output system (BIOS) firmware, which may be a standardized BIOS firmware. In addition, the SPI-ROM may support other few elementary operations. For instance, the SPI-ROM may support firmware for a Platform Security Processor (PSP) for running security-sensitive components while the computing system initializes. Further, for supporting the firmware for such various functions, the SPI-ROM and the processor are designed to interact through a standardized reference call mechanism.

For substantially optimal operation, such initialization components of the computing systems are, usually, designed in a manner that each SPI-ROM of a predetermined selected size, for instance, of 16 mega-bits (MB), can support the operation of two processors. In certain cases, such a design of the initialization components may be unable to perform few operations, and for such operations, the SPI-ROM may have to support more than two processors. However, if more than two processors are to be supported, an SPI-ROM of the same size may prove to be insufficient, owing to the other elementary operational data which is supported by the SPI-ROM, thereby leading to an ineffective operation. On the other hand, if the size of the SPI-ROM is increased to support more than two processors, then, firstly, the SPI-ROM and the processors may be unable to use the standardized reference call mechanism. Accordingly, a proprietary reference call mechanism may have to be devised for interaction and operation between the SPI-ROM and the processors.

Further, initialization data, such as BIOS firmware, may also have to be designed proprietarily for the larger SPI-ROM and the processors, which may deviate from the standardized initialization data. Accordingly, the use of a larger-sized SPI-ROM may be costly in terms of development of data, such as BIOS firmware or PSP firmware, which deviates from standardized data. In certain other techniques, two SPI-ROM of the same size, for instance, of 16 MB, may be used for supporting more than two processors. However, in such a case, the various operations supported by the SPI-ROM may conflict with each other and may not effectively operate, unless the firmware on the processors as well as the SPI-ROMs are designed in accordance with the modified configuration of the initializing components. In such cases too, the design of the data, such as firmware, may be costly and may, in turn, lead to an increase in the cost of the computing system.

Approaches for booting a processor are described, for example, in an environment supporting a plurality of processors and using a plurality of SPI-ROMs. The present subject matter provides approaches for booting the processor by supporting the plurality of processors using the plurality of SPI-ROMs without any modification in the standardized firmware. In other words, the processors and the SPI-ROMs operate on standardized firmware, while supporting each other in multiplicity. The technique provides for selection of one of the SPI-ROMs from amongst the plurality, and hence, the firmware, for operation with a processor in the plurality of processors. According to an aspect, the technique uses a pure hardware signal associated with the processor to identify the processor for which the SPI-ROM and the firmware is to be, accordingly, selected. In an example, the pure hardware signal can be a low-level signal which is generated by the processor in a semi-powered state, i.e., when the computing system has not been switched on yet and the processor is provided with an initial sustain power. In other words, while, generally, the computing systems have to be powered on to read the processor to be selected based on the internal register of the processor, in the present case, the processor can be identified without powering the system on.

According to an aspect, based on a CORETYPE value associated with the processor, the processor can be identified and the firmware relevant for the identified processor can be used for an operation, such as initialization, of that processor. In addition, based on the operation, the SPI-ROM can be selected for that processor. The CORETYPE value associated with the processor can be a pure hardware parameter for which the system does not have to be powered on. The CORETYPE signal can be used as the selection input, for example, based on which the firmware to be loaded is selected.

In said example, on the basis of the type of firmware to be prompted, the SPI-ROM is selected. In other words, if the BIOS firmware is to be prompted, then the SPI-ROM designed with the BIOS firmware is selected to support the processor, whereas if the PSP firmware is to be prompted, then the SPI-ROM designed with the PSP firmware is selected to support the processor. With such a design, as explained above, an appropriate SPI-ROM can be used for a certain operation. For instance, one SPI-ROM can be used for supporting the BIOS firmware whereas another can be used for supporting the PSP firmware. Such a division of operation can provide for an effective as well as efficient operation of the SPI-ROMs.

In an example, the present subject matter relates to a switching circuit which is provided with the functionality and intelligence as described above and which is able to select and match the processor to the appropriate SPI-ROM. The switching circuit, in an example, provided as a switching integrated circuit (IC), can switch the selection between different SPI-ROMs with different firmware based on the CORETYPE signal from the processor. The present subject matter provides that the switching circuit routes a chip select signal for selecting the appropriate SPI-ROM. In other words, the SPI-ROM is activated when the chip select signal is received from the switching circuit, otherwise the SPI-ROM remains in a disabled state, Therefore, based on the processor, which is identified based on the CORETYPE signal, the switching circuit determines the route on which the chip select signal is to be routed to access the appropriate firmware, and, then, boot the computing system. Accordingly, the present subject matter allows support for multiple processors using multiple SPI-ROMs in an effective manner, while at the same time minimizing boot time and firmware effort.

The above aspects are further described in conjunction with the figures, and in associated description below. It should be noted that the description and figures merely illustrate principles of the present subject matter. Therefore, various arrangements that encompass the principles of the present subject matter, although not explicitly described or shown herein, may be devised from the description and are included within its scope. Additionally, the word “coupled” is used throughout for clarity of the description and can include either a direct connection or an indirect connection.

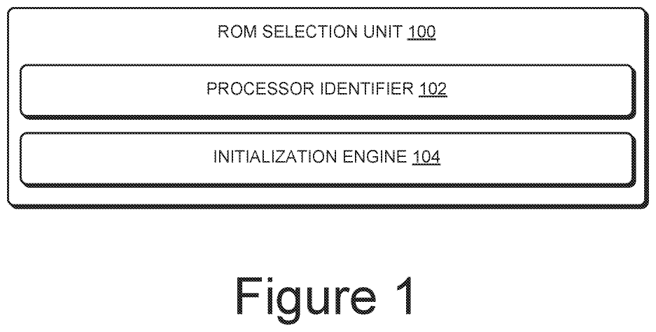

FIG. 1 illustrates a schematic of a Read-Only-Memory (ROM) selection unit 100 for booting a processor, according to an example. Accordingly, the ROM selection unit 100 can be a part of and operably coupled to a processing unit circuit supporting a plurality of processors to boot the processors. In said example, the processing unit circuit can further include a plurality of Serial Peripheral Interface Read-Only Memories (SPI-ROMs) which are operably coupled to the processing unit circuit. For example, a processor on the processing unit circuit can interact with an SPI-ROM that provides support for, amongst other things, an initialization operation associated with the computing system for starting up the computing system. For example, one SPI-ROM may be used for supporting a basic input-output system (BIOS) firmware, whereas another SPI-ROM may support firmware for a Platform Security Processor (PSP) for running security-sensitive components while the computing system initializes.

The ROM selection unit 100 selects one of the SPI-ROMs from amongst the plurality of SPI-ROMs, and hence, the firmware, for operation of each of the processors in the plurality of processors. In other words, for each processor in the processing unit circuit, the ROM selection unit 100 selects and allocates an SPI-ROM and the appropriate firmware so that the processor can carry out its operation.

In said example, the ROM selection unit 100 can include a processor identifier 102 and an initialization engine 104, The processor identifier 102 can determine a pure hardware parameter associated with the processor, for instance to be activated for operation, from amongst a plurality of processors, to identify the processor. The pure hardware parameter can be determined based on a signal received from the processor in a semi-powered state of the processor. For instance. The semi-powered state of the processor can be when the computing system has not been switched on yet and the processor is provided with an initial sustain power. Further, the initialization engine 104 can identify a firmware appropriate for booting of the processor, the firmware being identified based on identified processor. Accordingly, the initialization engine 104 can generate and transmit, based on the identified firmware, a chip select signal to a selected SPI-ROM to activate the SPI-ROM for booting the processor.

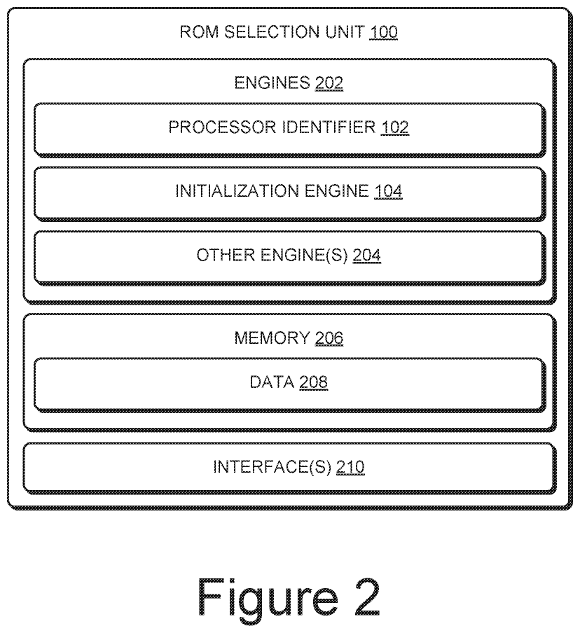

The operation of the ROM selection unit 100 is discussed in further detail with respect to FIG. 2.

FIG. 2 illustrates a detailed schematic of the ROM selection unit 100, in accordance with an example of the present subject matter. In said example, the ROM selection unit 100 can be deployed as a switching circuit which is provided with the functionality and intelligence to be able to select and match the processor to the appropriate SPI-ROM. For instance, the ROM selection unit 100 can be provided as a switching integrated circuit (IC), Accordingly, amongst other things, the ROM selection unit 100 may include engines 202 which can include the processor identifier 102 as well as the initialization engine 104. The engines 202 may be employed as a combination of hardware and programming (for example, programmable instructions) to use functionalities of the engines 202. In examples described herein, such combinations of hardware and programming may be used in a number of different ways. For example, the programming for the engines 202 may be processor executable instructions stored on a non-transitory machine-readable storage medium and the hardware for the engines 202 may include a processing resource (for example, processors), to execute such instructions. In the present examples, the machine-readable storage medium stores instructions that, when executed by the processing resource, deploy engines 202. In such examples, the ROM selection unit 100 may include the machine-readable storage medium storing the instructions and the processing resource to execute the instructions, or the machine-readable storage medium may be separate but accessible to ROM selection unit 100 and the processing resource. In other examples, engines 202 may be deployed using electronic circuitry. Further, the engines 202 may include other engine(s) 204. The other engine(s) 204 may provide functionalities that supplement applications or functions performed by the ROM selection unit 100.

In addition to the engines 202, the ROM selection unit 100 can include a memory 206 having data 208, and interface(s) 210. The engines 202, among other capabilities, may fetch and execute computer-readable instructions stored in the memory 206. The memory 206, communicatively coupled to the engines 202, may include a non-transitory computer-readable medium including, for example, volatile memory, such as Static Random Access Memory (SRAM) and Dynamic Random Access Memory (DRAM), and/or non-volatile memory, such as Read-Only-Memory (ROM), erasable programmable ROM, flash memories, hard disks, optical disks, and magnetic tapes. In addition, the data 208 includes may include data generated and saved by the engines 202 to provide various functionalities to the ROM selection unit 100.

As mentioned previously, in operation, the ROM selection unit 100 can use a pure hardware signal, such as a CORETYPE value, generated by the processors in a multiprocessor processing unit circuit, in the semi-powered state of the processors. For example, the semi-powered state can be when the computing system is provided with a sustain power which is the earliest power available before firmware is loaded. For instance, when a screen or a top cover of a laptop is lifted, the processor can assert the CORETYPE signal. This pure hardware signal can be used as a parameter to switch the selection between different SPI-ROMs with different firmware based on the CORETYPE signal from the processor. For instance, the ROM selection unit 100 can identify each processor individually and, then, select an appropriate firmware and an SPI-ROM for the operation of each processor.

In an example, each processor can generate two hardware signals, namely CORETYPE [1:0], and the processor identifier 102 can use the two hardware signals to identify different generations of processors within the same hardware family. Accordingly, in said example, the processor identifier 102 can read the CORETYPE1 and CORETYPE0 pins of each processor for identifying the processor for instance, the type. Based on the identified processor, the initialization engine 104 can identify an appropriate firmware to be initialized for booting the processor, and, in turn, on the basis of the type of firmware to be prompted, the initialization engine 104 can select the SPI-ROM for loading the firmware. In other words, the initialization engine 104 can initialize loading of the identified firmware to the selected SPI-ROM to boot the processor. In an example, the firmware can include BIOS firmware or PSP firmware.

As explained previously, the ROM selection unit 100 can be implemented as an IC switching circuit which can operate in the manner explained above. Accordingly, once the processor identifier 102 has identified the processor and the initialization engine 104 has determined the appropriate firmware and the SPI-ROM for loading the firmware, the initialization engine 104 can transmit a chip select signal for selecting the appropriate SPI-ROM. In other words, the initialization engine 104 can activate the SPI-ROM, otherwise the SPI-ROM remains in a disabled state, such as a high Z-state, in which state the SPI-ROM behaves as if it does not exist on the processing unit circuit. Therefore, based on the processor identified using its CORETYPE value, the ROM selection unit 100 can determine the route on which the chip select signal is to be transmitted to access the appropriate firmware, and, then, boot the identified processor.

The operation of the ROM selection unit 100 is explained further with reference to the following examples, which are not to be considered limiting in any manner, According to one example, according to one system architecture design, the PSP may be operational before a booting processor, such as an x86 processor, and therefore, the ROM selection unit 100 has to initialize the appropriate PSP firmware before the PSP is operational, i.e., before a power button of the computing system is activated. For instance, the initialization of the PSP firmware can commence when a screen or a top cover of a laptop is lifted. Accordingly, the processor identifier 102 can read the CORETYPE signal asserted by the PSP to determine that the PSP has to be operational. Consequently, the initialization engine 104 can determine the PSP firmware and also identify which SPI-ROM is to be selected, for initializing the appropriate firmware before the computing system is fully powered, for instance, so that the processor can be correctly booted.

According to another example, the booting processor may have to be initialized before other processors, and accordingly, the processor identifier 102 can receive the CORETYPE value from the booting processor to identify that the booting processor is to be initialized. Based on the identity of the processor, the initialization engine 104 can then select whether the BIOS firmware is to be prompted or the PSP firmware is to be prompted. For instance, if the BIOS firmware is to be prompted, then the initialization engine 104 can select the SPI-ROM designed with the BIOS firmware to support the processor. On the other hand, if the PSP is identified as the one to be initialized, as in the previous example, the initialization engine 104 can determine that the PSP firmware is to be prompted, and accordingly, select the SPI-ROM designed with the PSP firmware to support the processor.

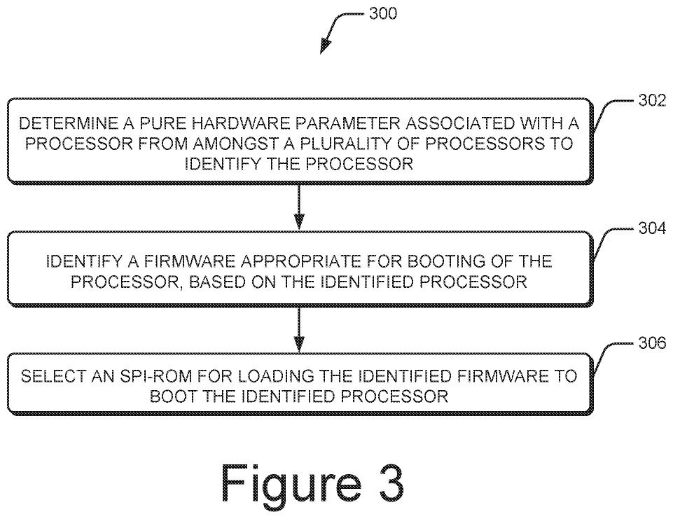

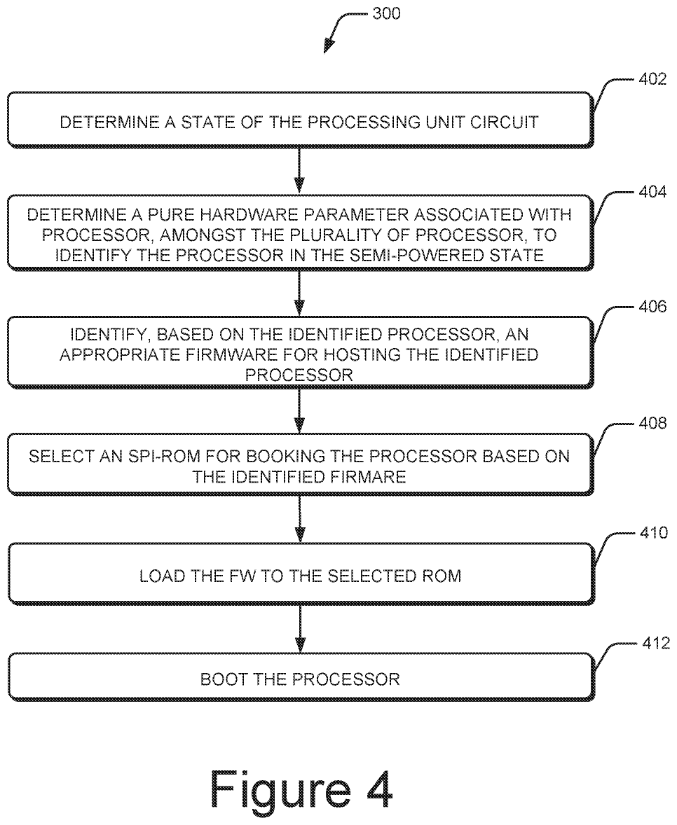

FIG. 3 and FIG. 4 illustrate a method 300 for booting a processor, in accordance with an example of the present subject matter. While FIG. 3 illustrates the method 300 for booting the processor in brief, FIG. 4 illustrates the method 300 in detail. The method(s) 300 may be described in the general context of computer executable instructions. Generally, computer executable instructions can include routines, programs, objects, components, data structures, procedures, engines, functions, etc., that perform particular functions or employ particular abstract data types. The method(s) 300 may also be practiced in a distributed computing environment where functions are performed by remote processing devices that are linked through a communications network. In a distributed computing environment, computer executable instructions may be located in both local and remote computer storage media, including memory storage devices.

The order in which the blocks in the method(s) 300 is described is not intended to be construed as a limitation, and any number of the described blocks can be combined in any order to employ the method(s) 300, or an alternative method. Additionally, individual blocks may be deleted from the method(s) without departing from the scope of the subject matter described herein. Furthermore, the method(s) 300 can be employed in any suitable hardware, software, firmware, or combination thereof. The method(s) 300 is explained with reference to the ROM selection unit 100, and for the sake of brevity, the components and details associated with the method(s) 300 described in FIG. 3 and FIG. 4 are not repeated. It will be understood that the method(s) 300 can be employed in other ROM selection units 100 as well.

Referring to method 300, at block 302, a pure hardware parameter associated with a processor, from amongst a plurality of processors, can be determined to identify the processor. For example, the pure hardware parameter can be a CORETYPE value generated by the processors in a multiprocessor processing unit circuit, in the semi-powered state of the processors. For instance, the semi-powered state can be when the computing system is provided with a sustain power which is the earliest power available before firmware is loaded when a screen or a top cover of a laptop is lifted.

At block 304, a firmware appropriate for booting of the processor is identified, based on the identified processor at block 302. Further, at block 306, an SPI-ROM is selected for loading the identified firmware to boot the identified processor. As part of selecting the SPI-ROM, the identified firmware is loaded to the SPI-ROM to initialize and boot the processor with the appropriate firmware.

As mentioned previously, FIG. 4 illustrates a detailed method 300 for booting a processor, according to an example of the present subject matter.

Referring to block 402, a state of a processing unit circuit is determined to determine that the processing unit circuit is in a semi-powered state. For example, the state of the processing unit circuit is determined based on the state of a computing device that the processing unit circuit is deployed in.

In response to determining that the state of the processing unit circuit is semi-powered state, the initialization of the processors commences. Accordingly, at block 404, a pure hardware parameter associated with a processor in a multiprocessor processing unit circuit, in the semi-powered state, is determined. The pure hardware parameter, such as a CORETYPE value asserted by the processor in the semi-powered state, can be used to identify the processor from amongst different generations of processors within a hardware family.

At block 406, based on the identified processor, an appropriate firmware is identified for booting that processor. For example, if the processor is identified to be a booting processor, such as an x86 processor, then the BIOS firmware can be identified to be prompted. In another example, if the processor is identified to be a PSP, then the PSP firmware can be prompted.

At block 408, the SPI-ROM relevant for loading the identified firmware can be selected. Continuing from the examples above, if BIOS firmware is to be prompted then the SPI-ROM designed for the BIOS firmware can be selected, whereas if the PSP firmware is to be initialized, then the SPI-ROM designed for the PSP firmware can be selected. As mentioned previously, the selection of the SPI-ROM is achieved by a switching circuit. The switching circuit can transmit a chip select signal for selecting the appropriate SPI-ROM to activate the selected SPI-ROM.

At block 410, the identified firmware can be loaded to the selected SPI-ROM to initialize the firmware. Further, at block 412, the processor can be booted using the initialized firmware. Accordingly, the present subject matter allows support for initializing and booting the processors in a multiprocessor environment using multiple SPI-ROMs, yet in an effective manner, while at the same time minimizing boot time and firmware effort.

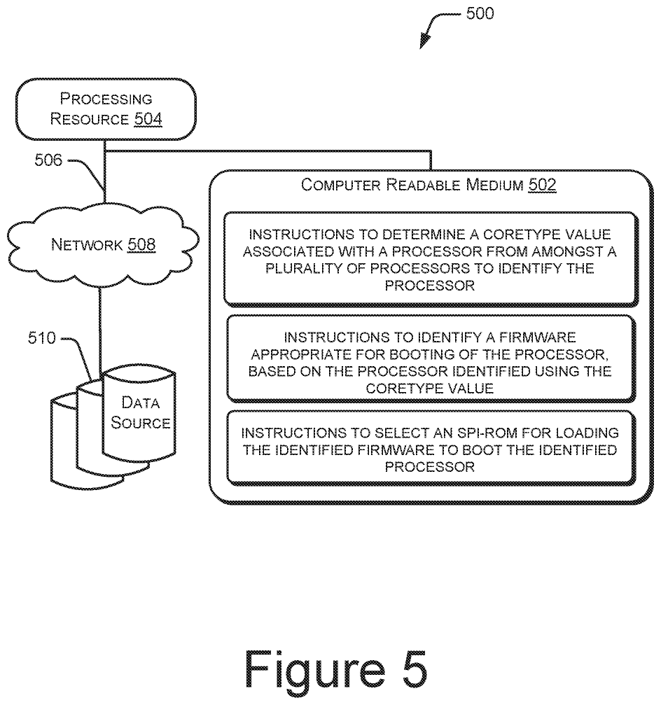

FIG. 5 illustrates a network environment 500 using a non-transitory computer readable medium 502 to boot processors, for instance, in a multiprocessor environment having multiple SPI-ROMs, according to an example of the present subject matter. The network environment 500 may be a public networking environment or a private networking environment. In one example, the network environment 500 includes a processing resource 504 communicatively coupled to the non-transitory computer readable medium 502 through a communication link 506.

For example, the processing resource 504 may be a processor of a computing system, such as the ROM selection unit 100. The non-transitory computer readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 may access the non-transitory computer readable medium 502 through a network 508. The network 508 may be a single network or a combination of multiple networks and may use a variety of communication protocols.

The processing resource 504 and the non-transitory computer readable medium 502 may also be communicatively coupled to data sources 510 over the network 508. The data sources 510 may include, for example, databases and computing devices. The data sources 510 may be used by the database administrators and other users to communicate with the processing resource 504.

In one example, the non-transitory computer readable medium 502 includes a set of computer readable and executable instructions, such as the processor identifier 102 and the initialization engine 104. The set of computer readable instructions, referred to as instructions hereinafter, may be accessed by the processing resource 504 through the communication link 506 and subsequently executed to perform acts for network service insertion.

For discussion purposes, the execution of the instructions by the processing resource 504 has been described with reference to various components introduced earlier with reference to description of FIG. 1 and FIG. 2.

On execution by the processing resource 504, the processor identifier 102 may determine a CORETYPE value associated with a processor from amongst a plurality of processors in the multiprocessor processing unit circuit, to identify the processor. For instance, the CORETYPE value associated with the processor can be a pure hardware signal, i.e., a low-level signal which is generated by the processor in a semi-powered state. For example, the processor may generate such a signal when the computing system has not been switched on yet and the processor is provided with an initial sustain power. In other words, while, generally, the computing systems have to be powered on to read the processor to be selected based on the internal register of the processor, in the present case, the processor can be identified without powering the system on. In an example, each processor can generate two hardware signals, namely CORETYPE [1:0], and the processor identifier 102 can use the two hardware signals to identify different generations of processors within the same hardware family.

Further, the initialization engine 104 can identify a firmware appropriate for booting of the processor, based on the processor identified using the CORETYPE value. Accordingly, the initialization engine 104 can select an appropriate SPI-ROM for loading the identified firmware to boot the identified processor. As an example, the SPI-ROM can be selected based on the identified firmware. if PSP firmware is identified to be initialized, then the SPI-ROM designed for the PSP firmware can be selected. As part of the selection of the SPI-ROM, the identified firmware can be loaded to the SPI-ROM to initialize the processor and facilitate the booting thereof.

Although aspects for booting a processor have been described in a language specific to structural features and/or methods, it is to be understood that the subject matter is not limited to the features or methods described. Rather, the features and methods are disclosed as examples for booting a processor.

I/We claim:

1. A method comprising:
determining a pure hardware parameter associated with a processor from amongst a plurality of processors to identify the processor;
identifying a firmware appropriate to boot the processor, based on the identified processor; and
selecting a Serial Peripheral Interface Read-Only Memory (SPI-ROM) to load the identified firmware to boot the identified processor, wherein the selecting comprises loading the identified firmware to the selected SPI-ROM.

2. The method as claimed in claim 1, wherein the pure hardware parameter is a CORETYPE value associated with the processor.

3. The method as claimed in claim 1, wherein pure hardware parameter is determinable in a semi-powered state of the processor.

4. The method as claimed in claim 1, wherein the firmware is one of basic input-output system (BIOS) firmware and Platform Security Processor (PSP) firmware.

5. The method as claimed in claim 1, wherein the determining comprises identifying the processor from amongst different generations of processors within a hardware family.

6. A Read-Only-Memory (ROM) selection unit comprising:
a processor identifier to determine a pure hardware parameter associated with a processor from amongst a plurality of processors to identify the processor, wherein the pure hardware parameter is determinable in a semi-powered state of the processor; and
an initialization engine to,
identify a firmware appropriate to boot the processor, based on identified processor; and
transmit, based on the identified firmware, a chip select signal to a selected Serial Peripheral Interface Read-Only Memory (SPI-ROM) to activate the SPI-ROM to boot the processor.

7. The ROM selection unit as claimed in claim 6, wherein the pure hardware parameter is a CORETYPE value associated with the processor.

8. The ROM selection unit as claimed in claim 6, wherein the firmware is one of basic input-output system (BIOS) firmware and Platform Security Processor (PSP) firmware.

9. The ROM selection unit as claimed in claim 6, wherein the processor identifier is to identify the processor from amongst different generations of processors within a hardware family.

10. The ROM selection unit as claimed in claim 6, wherein the initialization engine is to initialize loading of the identified firmware to the selected SPI-ROM to boot the processor.

11. A non-transitory computer-readable medium comprising computer-readable instructions which, when executed by a processing resource, cause the processing resource to:
determine a CORETYPE value associated with a processor from amongst a plurality of processors to identify the processor;
identify a firmware appropriate to boot the processor, based on the processor identified using the CORETYPE value; and
select a Serial Peripheral Interface Read-Only Memory (SPI-ROM) to load the identified firmware to boot the identified processor, wherein processing resource is to further load the identified firmware to the selected SPI-ROM.

12. The non-transitory computer-readable medium as claimed in claim 11, wherein the CORETYPE value associated with the processor determinable in a semi-powered state of the processor.

13. The non-transitory computer-readable medium as claimed in claim 11, wherein the firmware is one of basic input-output system (BIOS) firmware and Platform Security Processor (PSP) firmware.

14. The non-transitory computer-readable medium as claimed in claim 11 to cause the processing resource to identify the processor from amongst different generations of processors within a hardware family.

15. The non-transitory computer-readable medium as claimed in claim 11 to cause the processing resource to read the CORETYPE1 and CORETYPE0 pins of the processor to identify the processor.
